(19) United States
(12) Patent Application Publication
(10) Pub. No.: US 2003/0045139 A1
(43) Pub. Date: Mar. 6, 2003

(54) Receptacles for connecting electrical components between pins

(75) Inventor: Jeffrey W. Hanson, Redondo Beach, CA (US)

Correspondence Address: Fogg, Slifer & Polglaze, P.A., P.O. Box 581009, Minneapolis, MN, 55458-1009, US

(73) Assignee: ADC Telecommunications, Inc

(21) Appl. No.: 09/943,401

(22) Filed: Aug. 30, 2001

(51) Int. Cl. H01R 12/00

(52) U.S. Cl. 439/82

(57) ABSTRACT

A receptacle having a base and an electrical component mounted on the base is provided. At least two tubular connectors pass through the base. Each of the at least two tubular connectors is connected to the electrical component. Each of the at least two tubular connectors is for receiving a pin and is adapted to make electrical contact with the pin to electrically connect the electrical component to the pin.

### TECHNICAL FIELD

The present invention relates generally to the field of receptacles and, in particular, to receptacles for connecting electrical components between pins.

### BACKGROUND

Electrical components are frequently connected within circuits of printed circuit boards by connecting the leads of the electronic components between pins protruding from the printed circuit boards. For example, termination resistors are often connected between pairs of pins protruding from the circuit boards of various types of equipment used by local and long-distance telephone carriers for providing various services, such as T1 and/or DSL services.

In many situations, an electrical component is connected between a pair of pins by wire wrapping, which involves respectively wrapping each of a pair of lead-wires of the electronic component around each of the pair of pins. However, the lead-wires of many electronic components are generally too short for pin spacings that occur in a number of applications, making wire-wrap connections difficult to implement and resulting in wire-wrap connections of inferior quality. Moreover, the lead-wires of many electronic components are usually too brittle for wire wrapping and tend to break when wrapped around a pin. In many instances, wire wrapping exerts forces on the electronic components that are frequently sufficient to break the electronic components.

For example, the resistors typically used for termination resistors on the circuit boards of various types of equipment used by local and long-distance telephone carriers are often connected between a pair of pins by wire wrapping the lead-wires of the resistors around the pins. However, these lead-wires are generally too short for wire wrapping, so many of the wire-wrapped connections are difficult to make and are of inferior quality. The lead-wires of these resistors are usually brittle and frequently break during wire wrapping. Moreover, many of these resistors are cracked during wire wrapping, rendering them useless.

For the reasons stated above, and for other reasons stated below which will become apparent to those skilled in the art upon reading and understanding the present specification, there is a need in the art for connecting electronic components between pins in lieu wire wrapping.

### SUMMARY

The above-mentioned problems with using wire wrapping to connect electronic components between pins and other problems are addressed by embodiments of the present invention and will be understood by reading and studying the following specification. Embodiments of the present invention provide receptacles for connecting electronic components between pins without wire wrapping.

More particularly, in one embodiment, a receptacle having a base and an electrical component mounted on the base is provided. At least two tubular connectors pass through the base. Each of the at least two tubular connectors is connected to the electrical component. Each of the at least two tubular connectors is for receiving a pin and is adapted to make electrical contact with the pin to electrically connect the electrical component to the pin.

### BRIEF DESCRIPTION OF THE DRAWINGS

FIG. 1 is an isometric view of an embodiment of a receptacle according to the teachings of the present invention.

FIG. 2 is a side view showing the receptacle of FIG. 1 connecting an electronic component between a pair of pins according to the teachings of the present invention.

FIG. 3 is a cross-sectional view of an embodiment of a tubular connector.

FIG. 4 is a cross-sectional view showing the tubular connector of FIG. 3 passing through a base and receiving a pin according to the teachings of the present invention.

FIG. 5 is a block diagram of an embodiment of connections for connecting a component between a pair of pins.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

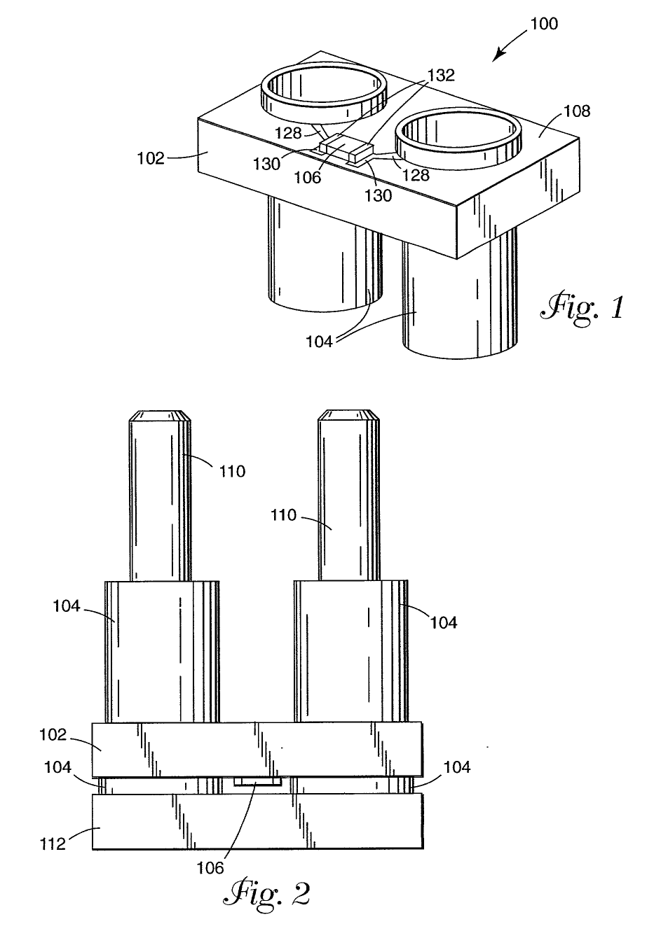

An embodiment of a receptacle 100 is illustrated in FIG. 1. Receptacle 100 includes a base 102, e.g., a printed circuit board, and a pair of tubular connectors 104 that pass through base 102. An electrical component 106, such as a resistor, capacitor, choke, inductor, diode, or the like, mounted on a surface 108 of base 102 is connected to each of the pair of tubular connectors 104. Each of the pair of tubular connectors 104 respectively receives a pin 110, as shown in FIG. 2, and is adapted to make electrical contact with pin 110 to electrically connect electrical component 106 to pin 110. In this way, receptacle 100 connects the electrical component 106 between a pair of pins 110 without wire wrapping. In one embodiment, each of pins 110 protrudes from a circuit board 112 and is respectively connected on each side of a break in a circuit. In this way, receptacle 100 inserts electrical component 106 into the circuit.

FIG. 3 is a cross-sectional view of an embodiment of tubular connector 104, which is fabricated from an electrical conductor, such as gold-plated brass, or the like. Tubular connector 104 has an outer cylindrical surface 114. In one embodiment, a knurl 116 is disposed on outer cylindrical surface 114. An axial bore 118 passes through tubular connector 104. Resilient fingers 120 are disposed within axial bore 118 so that resilient fingers 120 are coaxial with axial bore 118 and are in electrical contact with a surface 122 of axial bore 118. In one embodiment, resilient fingers 120 are electrical conductors, such as gold, silver, copper, or the like. In other embodiments, tubular connector 104 is available from Elpakco, Inc. as part number 4090-03-41-13.

FIG. 4 is a cross-sectional view showing tubular connector 104 passing through an aperture 123 in base 102. A bounding surface 124 surrounding aperture 123 is coated with an electrically conducting coating 126 of gold, silver, copper, or the like. Electrically conducting coating 126 makes electrical contact with outer cylindrical surface 114 of tubular connector 104. This electrically connects resilient fingers 120 to electrically conducting coating 126, since resilient fingers 120 are in electrical contact with surface 122 of axial bore 118. In one embodiment, knurl 116 is pressed into aperture 123 to make electrical contact with electrically conducting coating 126.

FIG. 4 also shows pin 110 as received in axial bore 118 of tubular connector 104. Resilient fingers 120 forcibly engage pin 110 so that pin 110 is in electrical contact with resilient fingers 120. Resilient fingers 120 electrically connect pin 110 to electrically conducting coating 126, since resilient fingers 120 are electrically connected to electrically conducting coating 126.

A pair of electrically conductive traces 128, e.g., copper, or the like, on surface 108 of base 102, as shown in FIG. 1, respectively contact the electrically conducting coating 126 that coats the bounding surface 124 of aperture 123 for each of the pair of tubular connectors 104, as shown in FIG. 4. Each of the electrically conductive traces 128 is respectively connected to a pair of electrically conductive pads 130, e.g., solder pads, on surface 108 of base 102. Electrical component 106 is surface mounted on electrically conductive pads 130 so that each of electrically conductive pads 130 is respectively connected to a contact 132 of electrical component 106.

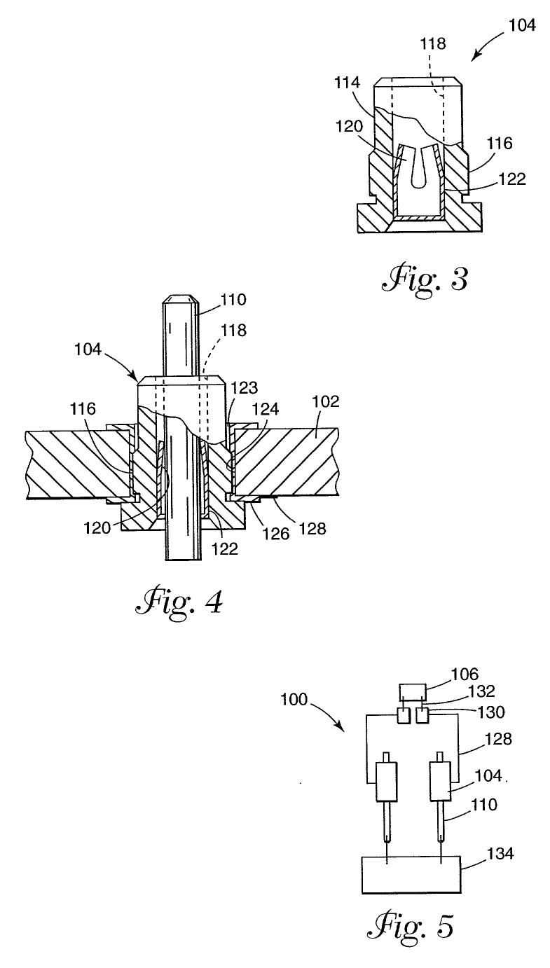

FIG. 5 is a block diagram that shows receptacle 100 connecting electrical component 106 between pins 110. Contacts 132 of electrical component 106 connect electrical component 106 to electrically conductive pads 130. Electrically conductive traces 128 connect electrically conductive pads 130 to tubular connectors 104 via electrically conducting coating 126. Tubular connectors 104 are connected to pins 110 via resilient fingers 120. In one embodiment, electrical component 106 is connected in a circuit 134 by pins 110.

To manufacture receptacle 100, a pair of apertures 123 are formed in base 102. The bounding surface 124 surrounding aperture 123 is coated with electrically conducting coating 126. Electrically conductive traces 128 are formed on base 102 to make contact with electrically conducting coating 126. Electrically conductive pads 130 are formed on base 102 to make contact with electrically conductive traces 128. Tubular connectors 104 are received in apertures 123 to make electrical contact with electrically conducting coating 126, e.g., by pressing knurl 116 into apertures 123. Contacts 132 of electrical component 106 are attached to electrically conductive pads 130, e.g., by soldering.

### Conclusion

Embodiments of the present invention have been described. The embodiments provide receptacles for connecting electronic components between pins without wire wrapping.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. For example, receptacle 100 can have three tubular connectors 104 passing through base 102, where each of the three tubular connectors 104 is connected to each of the three leads of a three-lead electronic component, such as a transistor. Receptacle 100 can then be used to connect the three-lead electronic component between three pins 110 protruding from a circuit board by receiving each of the three pins in each of the three tubular connectors 104.

What is claimed is:

1. A receptacle comprising:
a base;
an electrical component mounted on the base; and
at least two tubular connectors passing through the base, each of the at least two tubular connectors connected to the electrical component, each of the at least two tubular connectors for receiving a pin and adapted to make electrical contact with the pin to electrically connect the electrical component to the pin.

2. The receptacle of claim 1, wherein the base is a circuit board.

3. The receptacle of claim 1, wherein each of the at least two tubular connectors pass through an aperture in the base.

4. The receptacle of claim 3, wherein a bounding surface surrounding the aperture is coated with an electrically conducting coating that contacts the respective one of the at least two tubular connectors passing through the aperture.

5. The receptacle of claim 1, wherein each of the at least two tubular connectors make contact with an electrically conducting coating.

6. The receptacle of claim 1, and further comprising at least two electrically conducting traces disposed on the base, each of the at least two electrically conducting traces respectively connecting each of the at least two tubular connectors to the electrical component.

7. The receptacle of claim 1, wherein each of the at least two tubular connectors comprises resilient fingers for forcibly engaging the pin to electrically connect the electrical component to the pin.

8. The receptacle of claim 1, wherein each of the at least two tubular connectors comprises a knurl that contacts an electrically conducting coating.

9. The receptacle of claim 1, and further comprising at least two electrically conducting pads disposed on the base, each the at least two electrically conducting pads connected to the electrical component.

10. A receptacle comprising:
a base;
at least two electrically conducting pads disposed on the base;
an electrical component connected to the at least two electrically conducting pads;
at least two electrically conducting traces disposed on the base, each of the at least two electrically conducting traces respectively connected to each of the at least two electrically conducting pads; and
at least two tubular connectors passing through the base, each of the at least two tubular connectors respectively connected to each of the at least two electrically conducting traces, each of the at least two tubular connectors for receiving a pin and adapted to make electrical contact with the pin to electrically connect the electrical component to the pin via the respective one of the at least two electrically conducting traces and the respective one of the at least two electrically conducting pads.

11. The receptacle of claim 10, wherein each of the at least two tubular connectors make contact with an electrically conducting coating.

12. The receptacle of claim 10, wherein each of the at least two tubular connectors comprises resilient fingers for forcibly engaging the pin to electrically connect the electrical component to the pin.

13. A receptacle comprising:
a base;
at least two electrically conducting pads disposed on the base;
an electrical component connected to the at least two electrically conducting pads;
at least two electrically conducting traces disposed on the base, each of the at least two electrically conducting traces respectively connected to each of the at least two electrically conducting pads; and
at least two tubular connectors, each of the at least two tubular connectors passing through an aperture in the base and in electrical contact with an electrically conducting coating that coats a bounding surface surrounding the aperture, the electrically conducting coating making electrical contact with a respective one of the at least two electrically conducting traces, each of the at least two tubular connectors for receiving a pin and comprising resilient fingers for forcibly engaging the pin to make electrical contact with the pin to electrically connect the electrical component to the pin via the electrically conducting coating, the respective one of the at least two electrically conducting traces, and the respective one of the at least two electrically conducting pads.

14. The receptacle of claim 13, wherein each of the at least two tubular connectors comprises a knurl that contacts the electrically conducting coating.

15. A method for manufacturing a receptacle, the method comprising:
forming at least two apertures in a base;
receiving respectively each of at least two tubular connectors within the at least two apertures, each of the at least two tubular connectors for receiving a pin and adapted to make electrical contact with the pin; and
connecting an electronic component to each of the at least two tubular connectors by mounting the electronic component on the base.

16. The method of claim 15, and further comprising coating a bounding surface surrounding each of the at least two apertures with an electrically conducting coating.

17. The method of claim 15, wherein receiving respectively each of the at least two tubular connectors within the at least two apertures comprises respectively forming electrical contact between each of the at least two tubular connectors and an electrically conducting coating that coats a surface surrounding each of the at least two apertures.

18. The method of claim 17, wherein forming electrical contact between each of the at least two tubular connectors and an electrically conducting coating that coats the surface surrounding each of the at least two apertures comprises pressing a knurl on each of the at least two tubular connectors into each of the at least two apertures.

19. The method of claim 15, and further comprising forming at least two electrically conducting traces in the base between the at least two tubular connectors and the electronic component.

20. The method of claim 15, and further comprising forming at least two electrically conducting pads on the base between the at least two tubular connectors and the electronic component.

21. The method of claim 20, wherein mounting the electronic component on the base comprises connecting the electronic component to each of the at least two electrically conducting pads.

22. The method of claim 19, wherein connecting the electronic component to each of the at least two tubular connectors comprises using each of the at least two electrically conducting traces to respectively connect each of the at least two tubular connectors to the electronic component.

23. The method of claim 16, wherein connecting the electronic component to each of the at least two tubular connectors comprises connecting the electronic component to the electrically conducting coating on the bounding surface surrounding each of the at least two apertures.

24. A method for manufacturing a receptacle, the method comprising:
forming at least two apertures in a base;
forming at least two electrically conducting traces on the base;
receiving respectively each of at least two tubular connectors within the at least two apertures, each of the at least two tubular connectors for receiving a pin and adapted to make electrical contact with the pin;
connecting respectively each of the at least two electrically conducting traces to each of the at least two tubular connectors; and
connecting an electronic component to each of the at least two electrically conducting traces by mounting the electronic component on the base.

25. The method of claim 24, wherein connecting respectively each of the at least two electrically conducting traces to each of the at least two tubular connectors comprises coating a bounding surface surrounding each of the at least two apertures with an electrically conducting coating so that the electrically conducting coating that coats the surface surrounding each of the at least two apertures respectively contacts each of the at least two electrically conducting traces.

26. The method of claim 25, wherein connecting respectively each of the at least two electrically conducting traces to each of the at least two tubular connectors comprises respectively forming electrical contact between each of the at least two tubular connectors and the electrically conducting coating that coats the surface surrounding each of the at least two apertures.

27. The method of claim 24, and further comprising forming at least two electrically conducting pads on the base so that each of the at least two electrically conducting pads respectively makes contact with each of the at least two electrically conducting traces.

28. The method of claim 27, wherein connecting an electronic component to each of the at least electrically conducting traces by mounting the electronic component on the base comprises connecting the electronic component to each of the at least two electrically conducting pads.

29. A method for manufacturing a receptacle, the method comprising:
forming at least two apertures in a base;
coating a bounding surface surrounding each of the at least two apertures with an electrically conducting coating;
forming at least two electrically conducting traces on the base so that each of the at least two electrically conducting traces respectively makes contact with the electrically conducting coating that coats the surface surrounding each of the at least two apertures;
forming at least two electrically conducting pads on the base so that each of the at least two electrically conducting pads respectively makes contact with each of the at least two electrically conducting traces;
receiving respectively each of at least two tubular connectors within the at least two apertures so that each of the least two tubular connectors respectively contact the electrically conducting coating that coats the surface surrounding each of the at least two apertures, each of the at least two tubular connectors for receiving a pin and adapted to make electrical contact with the pin; and
connecting an electrical component to each of the at least two electrically conducting pads.

30. The method of claim 29, wherein receiving respectively each of at least two tubular connectors within the at least two apertures comprises pressing a knurl on each of the at least two tubular connectors into each of the at least two apertures.
